(19) United States
(12) Patent Application Publication
(10) Pub. No.: US 2022/0318802 A1
(43) Pub. Date: Oct. 6, 2022

(54) A WORKSTATION FOR INTERNET TRANSACTIONS BETWEEN NON-BUSINESS USERS

(71) Applicant: TALOS S.R.L., Mantova (MN) (IT)

(72) Inventor: Andrea CARAZZA, Borgo Virgilio (IT)

(21) Appl. No.: 17/640,427

(22) PCT Filed: Sep. 7, 2020
(86) PCT No.: PCT/IT2020/000063

§ 371 Date: Mar. 4, 2022

(30) Foreign Application Priority Data
Sep. 9, 2019 (IT) 102019000015923

(51) Int. Cl. G06Q 20/40; G06Q 20/02; G06Q 30/06

(52) U.S. Cl. CPC G06Q 20/401; G06Q 20/02; G06Q 30/0613; G06Q 30/0609

(57) ABSTRACT

A workstation is disclosed for internet transactions between non-business users substantially consisting of a series of desktop apparatuses and of a series of movable apparatuses that interact with one another to permit the operation of the workstation itself and the desktop apparatuses feature: computers, screens, printers, scanners, mouse devices, keyboards, cameras, whereas the movable apparatuses feature: smartphones, tablets, notebooks, ultrabooks and the connection and interaction method between the different apparatuses is by internet connection or WIFI between the desktop apparatuses and 3g, 4g, 4.5g, 5g, LTE, WIFI connection between the movable apparatuses. The workstation provides different apparatuses that interact between one another in response to the action of at least two parties who are a buyer and a seller and a third party who is a courier for transporting the item that is the object of the sale. The workstation in question is provided with an operating procedure for performing a sale transaction concerning an item, a corresponding payment and delivery of the item that comprises a series of operating steps including: sending a request, opening a procedure, sending money and a photograph, selecting the method of shipment and delivery and selection of a third party with the function of courier and closure of the transaction with the item being delivered to the buyer and the money being transferred to the seller.

### TECHNICAL FIELD

This invention refers to a workstation for internet transactions between non-business users that is particularly suitable for having a tool for managing the sale of items between non-business users without the risk of fraud.

### BACKGROUND ART

As is known, in recent years, internet purchases have been growing constantly and today sales sites have multiplied and with them frauds and in particular in transactions between non-business users. Currently, online purchase operations managed by companies like Amazon, Zalando, etc. are guaranteed by very attentive and precise customer care provided by operators for customers and also payments are secure and if purchased products are returned refunds are certain.

The situation is on the other hand very different in the case of the exchange of items between non-business users, where unfortunately there are frequent frauds that lead to the loss of the item and the money by the purchaser and/or the seller.

A first problem encountered in transactions between non-business users is due to the fact that there is no uniformity in registration profiles. In fact, currently, in order to activate an account just a few data suffice like full name and email, but this data can be invented, falsified, duplicated or be a false name so that, for example, it is not possible for a potential purchaser to be certain that these data correspond to a person with that full name. This ease of opening an account enables just one user to reproduce, close and reopen many different profiles and accounts.

Another problem arises from the excessive “freedom of action” for the parties (both for the buyer and for the seller). In fact, the seller may offer a product that is not actually in the possession of the seller so that once payment has been made the buyer does not receive the goods or receives an item that is not the item offered for sale; in this manner, no real guarantee exists for the parties during the negotiation with the result that it becomes very difficult to request refunding of the money paid and the bureaucratic refunding procedures are not always successful and are anyway very long, complicated and costly.

As mentioned, transactions between non-business users are not fully protected, apart from some payments such as for example Paypal that provide a possible refund guarantee, but only a posteriori after proceedings have been opened for fraud, which must have occurred and which inevitably causes delays, bureaucracy and costs for all parties.

It has been found that in most cases the “weak” party is currently the buyer. It is precisely for this reason that there are countless computer frauds by persons who for example place a large number of advertisements with “moderate” prices and once the purchaser makes the payment the seller absconds and the item is no longer shipped.

The procedure for refunding in the above example is very slow and expensive. This is above all because the seller or the transaction are not always easy to identify because of a problem of privacy. Further, in frauds for smalls amounts of 150 euros or less (which are the most used amounts in online frauds), the costs of lawyers, registered letters and possible court hearings (if a complaint is lodged with the postal police) would be much greater than the amount lost in the fraud, without considering the very long time frame (years). That is why 99% of people who suffer a scam do not follow up their complaint. Basically, who will embark on a long bureaucratic process for 150.00 euros that would certainly cost more than the sum lost without the certainty of actually recovering the sum? For the reasons that have just been illustrated, many frauds are encountered regarding items that involve moderate costs.

In addition to what has been so far illustrated, an item is chosen by verifying the reliability of the vendor, the chosen methods of payment and the methods of shipment to make the operation more secure and reliable and, when possible, collection in person is in fact chosen but all these markers limit and constrain the choices because sometimes the preferred item is renounced and an equivalent or similar item is sought in order to remain with sellers who are deemed to be reliable, this constraining and limiting the choices and the possibilities. However, these steps often do not suffice and the only thing that can be done is to hope that everything works out properly and that there are no snags or deception. One need that is keenly felt by non-business buyers on the internet is to be able to succeed in having tranquility, transparency and security in a sale that is secure, abandoning the fear of being defrauded with the pleasure of being able to choose, negotiate and purchase an item in serenity and security.

### DISCLOSURE OF INVENTION

The object of this invention is substantially that of solving the problems of the prior art by overcoming the aforesaid difficulties by a workstation for internet transactions between non-business users that enables all users to select the items without any fear of encountering false advertisements having a payment process dedicated to non-business users to prevent frauds in the purchase and sale of goods.

A second object of this invention is to have a workstation for internet transactions between non-business users that is able to offer a secure account that is not modifiable and/or falsifiable.

A third object of this invention is to have a workstation for internet transactions between non-business users that enables total transparency of the sequence of the transaction operations to be obtained, protecting upstream both the buyer and the seller and ensuring that the seller obtains the sum of money only when the buyer receives the item and checks that it corresponds to the item selected.

Another object of this invention is to have a workstation for internet transactions between non-business users that is able to make the users proceed with steps that are visible to both the buyer and to the seller so as to constrain the choices between the parties, obtaining a constrained alternating system that leaves no space for anybody to avoid the system.

A further object of this invention is to have a workstation for internet transactions between non-business users that is able to offer a system of constrained alternate exchanges for both parties interacting on the progress of the negotiation, controlling all steps, but without the possibility of modifying the system significantly in order to commit a scam to protect the parties.

Not the last object of this invention is to devise a workstation for internet transactions between non-business users that is easy to devise and works well.

These objects and still others that will become more apparent in the course of the present description are substantially achieved by a workstation for internet transactions between non-business users, as claimed below.

### BRIEF DESCRIPTION OF DRAWINGS

Further features and advantages will become clearer from the detailed description of a workstation for internet transactions between non-business users, according to this invention, given below with reference to the attached drawings, provided only by way of approximate and thus non-limiting example in which:

FIG. 1 shows, schematically, the operating mode with which a workstation for internet transactions between non-business user that is the object of this invention operates;

FIG. 2 shows, schematically, an element of the workstation in question for creating a account;

FIG. 3 shows, schematically, the element of FIG. 2 at the start of the procedure for selling an item:

FIG. 4 shows, schematically, the element of FIG. 2 in the step of a buyer sending a request;

FIG. 5 shows, schematically, the step of a seller opening a procedure;

FIG. 6 shows, schematically, the element of FIG. 2 in the step of a buyer sending money;

FIG. 7 shows, schematically, the step of a seller sending photographs;

FIG. 8 shows, schematically, the element of FIG. 2 in the step of a seller managing the method of shipping of an item;

FIG. 9 shows, schematically, the element of FIG. 2 in the step of a buyer closing the transaction:

FIG. 10 shows, schematically, the step of a seller closing the transaction procedure;

FIG. 11 shows, schematically, the step of the buyer closing the transaction procedure:

FIG. 12 shows, schematically, the step of a seller closing the transaction procedure;

FIG. 13 shows schematically the sequence of operating steps during the sale procedure;

FIG. 14 show the sequence of the different steps that occur between two users during a transaction for the sale of an item.

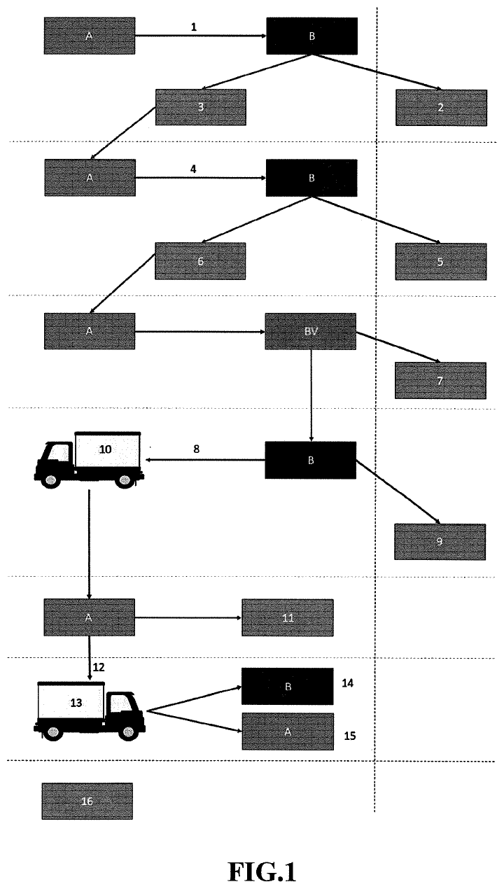

With reference to the cited figures and in particular to FIG. 1, the operating plan of a workstation for internet transactions between non-business users, according to this invention has been indicated overall.

### BEST MODE FOR CARRYING OUT THE INVENTION

The workstation in question substantially consists of a series of desktop apparatuses and of a series of movable apparatuses that interact with one another to enable the workstation in question to operate.

The desktop apparatuses feature: computers, monitors, printers, scanners, mouse devices, keyboards, and cameras, while the mobile devices include: smartphones, tablets, notebooks, ultrabooks. The connection and interaction method between the different devices is via an internet or WiFi connection between the desktop devices and via a 3G, 4G, 4.5G, 5G, LTE, or WiFi connection between the mobile devices.

The workstation provides different apparatuses that interact between one another in response to the action of at least two parties who are a buyer and a seller and a third party who is a courier for transporting the item that is the object of the sale.

In order to be active, the workstation enables a buyer to operate with a desktop computer provided with a screen and a printer to be able to print material and forms and with a movable apparatus and, similarly, a seller can operate with a desktop computer connected to a scanner, with a camera to photograph the item that the seller intends to sell or a movable apparatus like a smartphone, tablet, notebook as will be illustrated below.

A courier also intervenes in the procedure who will work with computers and printers, telephones, smartphones, tablets and notebooks to be able to communicate and operate both with the seller and with the buyer and use means of transport like cars, vans or trucks. As previously mentioned, the different apparatuses cited interact with one another via the internet, as will be clear from the description of the operating sequence.

The workstation in question ensures that both the seller and the buyer create an account to be able to interact with one another during the different steps of the transaction for the sale of an item.

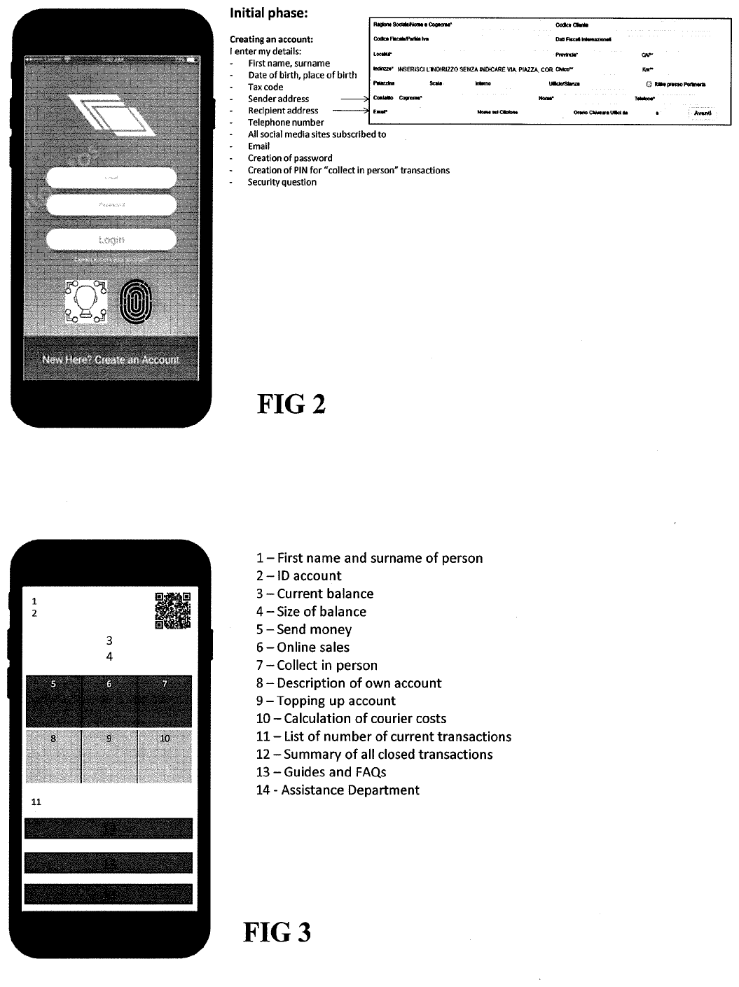

In order to create an account, the person has to enter his or her data, as shown in FIG. 2, like:
Full name
Place and date of birth
Tax ID code
Collection address
Delivery address
Telephone number
All the social networks for which the users have signed up
Email
Creation of a password
Creation of a PIN for «collect in person» transactions
Security question.

This data can be altered when necessary.

Once an account has been created, the preliminary phase comprises an exchange of emails between the system and the user to verify activation, which is confirmed by a message on the new user's telephone.

But in order to make and receive payments, the user has to:
enter at least one fingerprint, preferably of a predetermined finger, or all fingerprints and/or
combine facial recognition methods (if just one parameter is inserted that one is used but if both are combined both have to be used to make the payment),
scan identity card.
scan utilities bill (electricity or telephone bill for example).

This data can be modified only by a request (e.g. change of place of residence, replacing identity card, etc.) to safeguard the authenticity and uniqueness of the account.

After this step, the verification has to be awaited that will combine the data with an account. In this manner, each profile will be unique and copies will not be possible so each person can have only one account. After all the illustrated operations have been completed, the person will be assigned an ID identification code.

At this point, a credit/debit card or the credentials of a current account can be assigned. In particular, with the operating and procedural method described for activating an account, the workstation according to this invention modifies the concept of account, inasmuch as it is no longer based on falsifiable data. In fact, until today, the data requested for any account were full name/email. But they could be duplicated and invented so that a single user could create, close and reopen innumerable accounts.

On the other hand, during registration with the portal of the platform according to this invention, the real and unique data of the person is entered (fingerprints, facial recognition, identity card and/or copy of a utility bill) in order to make it almost impossible to create multiple profiles and by doing so, in the event of a possible dispute the bureaucratic path would be much faster inasmuch as the data of the parties concerned is available immediately without having to carry out searches as, on the other hand, occurs with known and currently used systems. The operating platform provided by the workstation in facts means that only one profile can be created for each user. The same person can also possibly open a profile as a company but in order to do so other data and documents will have to be entered such as for example tax code, VAT number and the Companies Register data.

The operating procedure of the platform in question for performing a transaction to buy an item, a corresponding payment and delivery of the item comprises a series of operating steps including: sending a request, opening a procedure, sending money and a photograph, selecting the method of shipping and delivery with selection of a third party with the function of courier and closure of the transaction with the item being delivered to the buyer and the money being transferred to the seller as shown schematically in FIG. 1.

The procedure provides an initial screen on which all the operating possibilities are shown provided by the system as shown in FIG. 3.

In particular, the procedure provides direct communication between buyer A and seller B by opening a virtual procedure that starts with a preliminary request to open a procedure initiated by the buyer, who is interested in the purchase of an item put up for sale by the seller B.

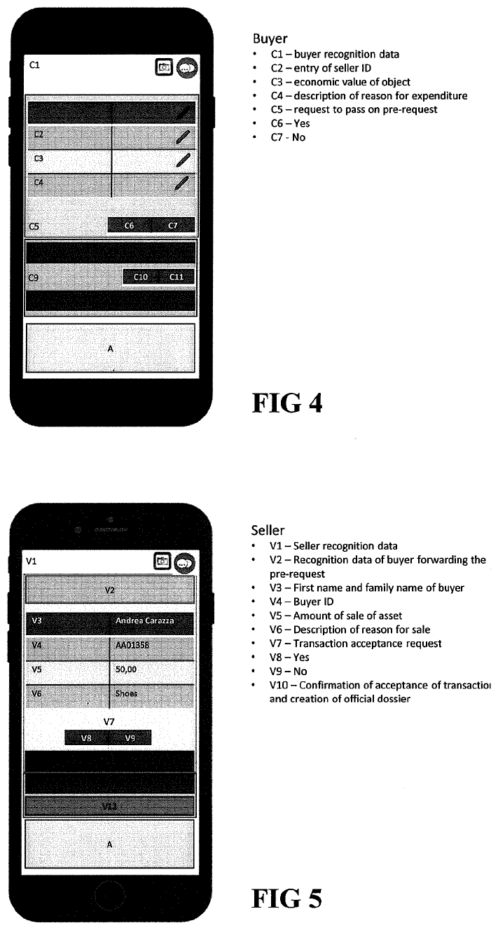

In greater detail, during the operating step of sending the request, the buyer A will send a pre-request to the seller B, entering the amount, the description of the object and the ID of the seller indicated in the account as shown in FIG. 4. The seller who receives the request (FIG. 5) will have the option of accepting the request or not. In the first case, the pre-request will remain suspended and after 12 hours will be closed automatically. Otherwise, the buyer is sent permission by the seller to formalize and continue the procedure.

At this point, through the seller agreeing to the negotiation, the next step is entered into that consists of the step of opening the procedure proper.

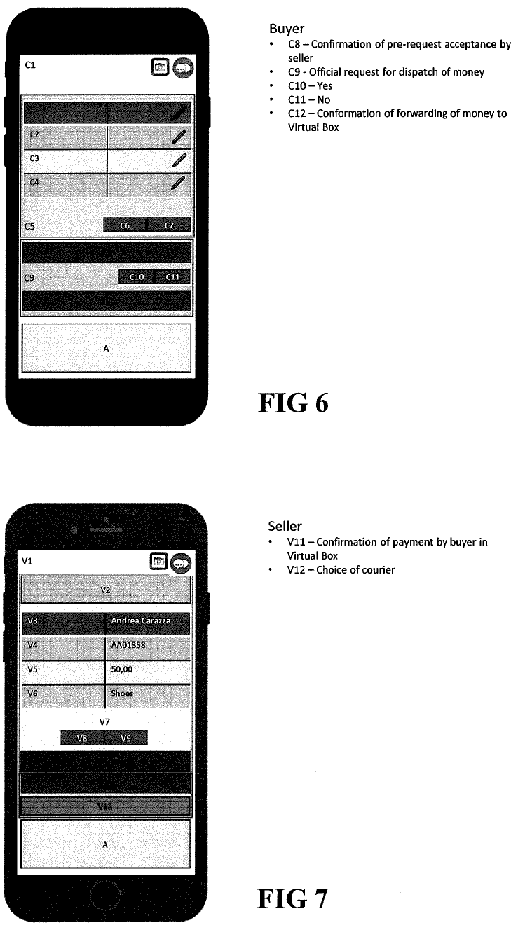

At the moment in which the seller accepts the pre-request, a “permission” (FIG. 6) message reaches the buyer, so the buyer can proceed with the official request and when the procedure/request is formalized, the seller activates a message requesting the sending of the money.

After the previously illustrated operations have been completed, the subsequent step of sending money is entered into.

In fact, once the negotiation is accepted, the seller sends detailed information on the item backed up by descriptive photographs and anything else that is requested (including videos) in order to describe and illustrate better the item that is the object of the negotiation, and the buyer will place the agreed amount in a dedicated box (FIG. 6) so that the seller can check that the money agreed in the previous steps are actually placed by the buyer. In the exchange of information between parties regarding the item, the more details the buyer obtains, the greater the protection overall for the transaction. In particular, the buyer can thus best decide whether to proceed with the purchase. In addition, in the event of a dispute, the person who has to manage and analyze the procedure will have more details and elements available that can be evaluated. In fact, all the steps that occur between the seller and buyer are inserted into a chat inside the procedure in which all the exchanges of information and data that seller and buyer exchange are collected. The contents of the chat remains present for evaluation and analysis by customer care in the event of a dispute between the parties. Once the procedure has been successfully completed the chat will be eliminated automatically.

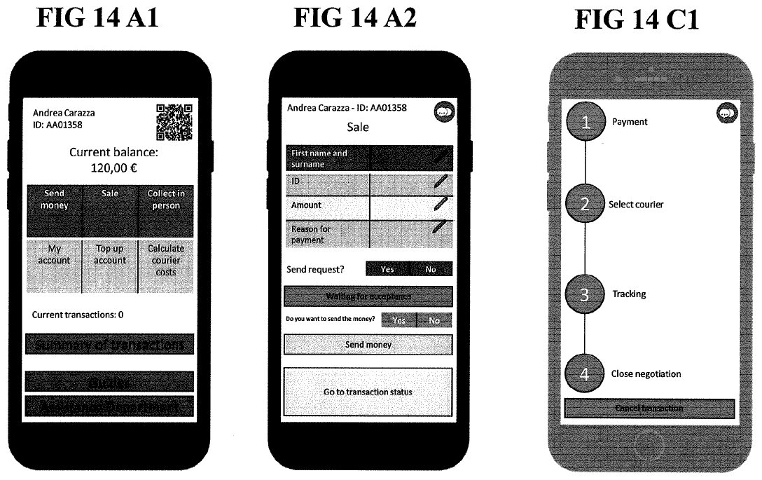

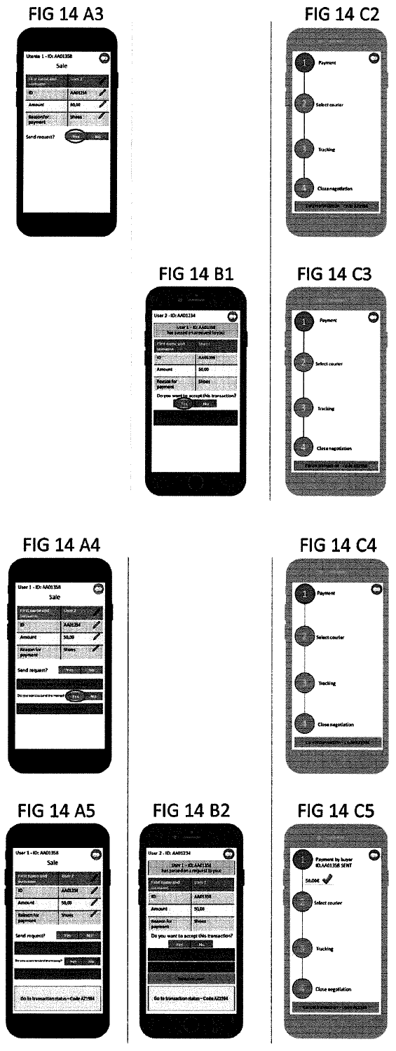

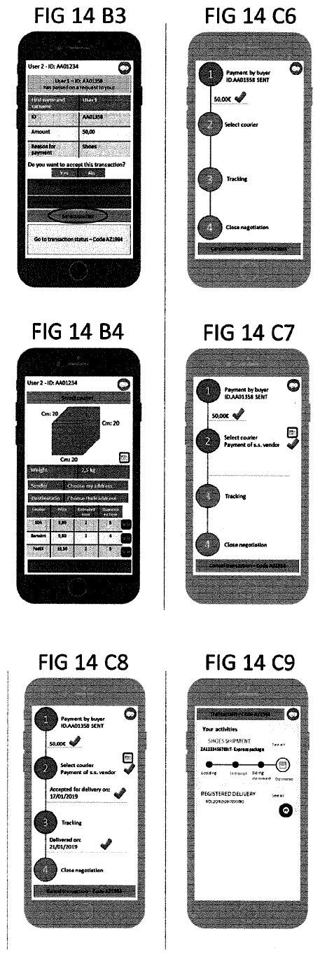

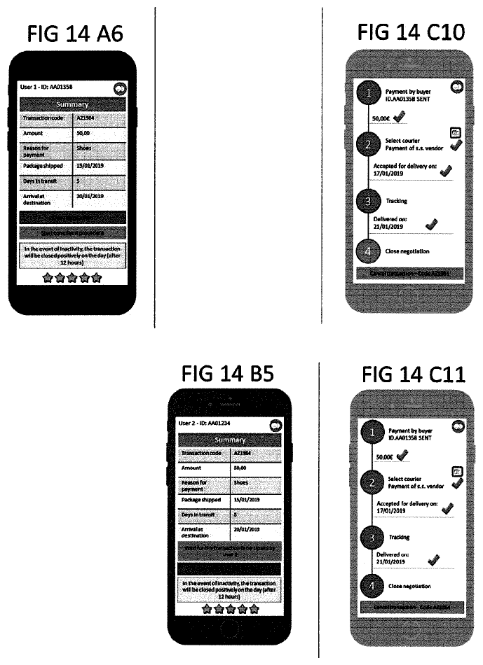

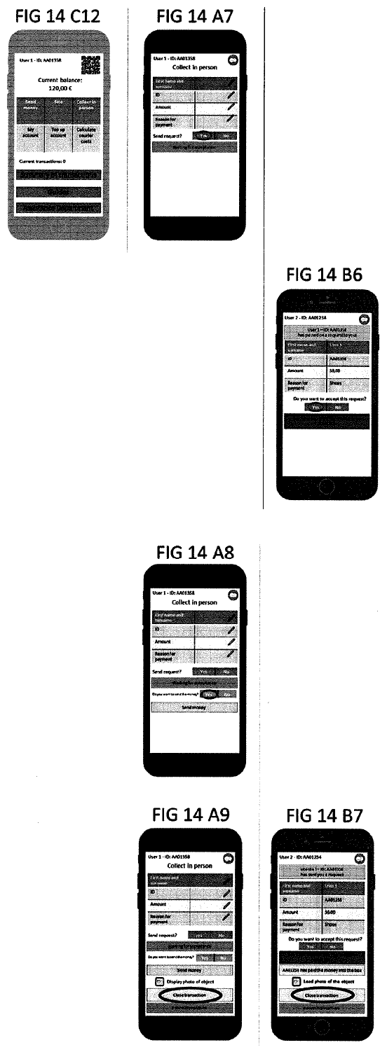

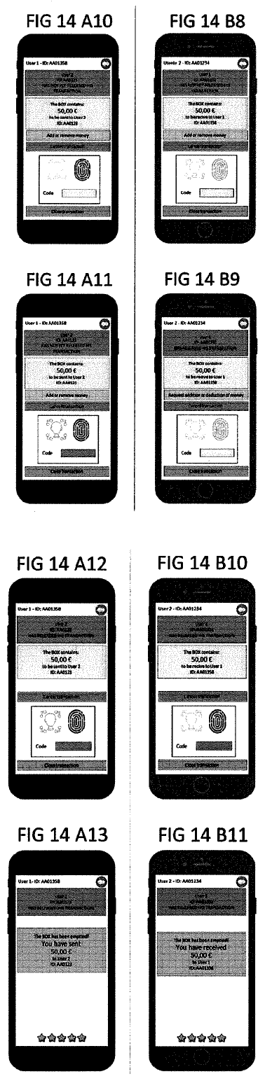

In this step, the agreed amount will not however arrive directly in the account of the seller, but will remain parked in a dedicated “virtual” box VB that is visible to both parties (FIG. 1 and FIG. 14C5).

At this point, the seller will have two possibilities: remaining inactive and not doing anything or proceeding with the shipment as shown in FIG. 7. In the first case, after 12 hours of inactivity, the money contained in the “virtual box” will be returned to the buyer, in the second case the next step is entered into of choosing the method of shipment and one of the couriers accredited by the system for the delivery.

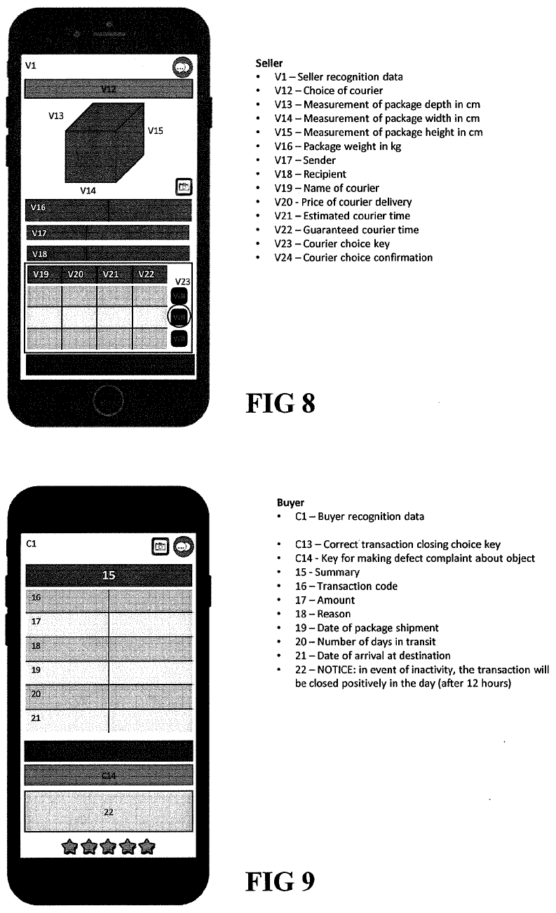

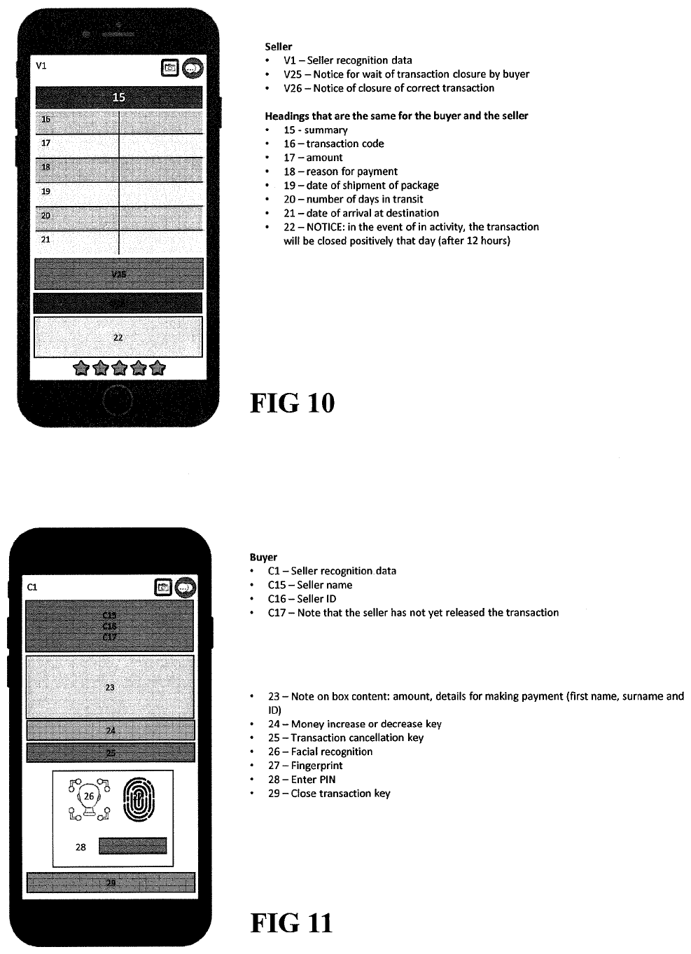

In this step, the seller can choose the details of the shipment (FIG. 8) by entering different data like the dimensions of the package, the collection and delivery address, selecting the courier and paying the cost of shipment.

The procedure that has so far been engaged in between the two parties, the seller A and buyer B, involves a third party, who is a courier so that the step is entered into of choosing the method of shipment and delivery with selection of the courier.

After arriving at this point of the procedure, the courier 10 will first send an email to both parties in which the courier will notify the parties of the acceptance of the item and then the courier 10 will send the seller a form that has already been filled in with all the data of the procedure.

The form must be printed and placed inside the package by the seller before delivery of the package to the chosen courier. If the seller forgets to enclose the form, the courier can do so, who possesses a copy as it is contained in the procedure.

At the moment of collection by the courier, if the seller is not found two times running, an alert message will be issued and the money contained in the “virtual box” will be returned to the buyer, whilst the amount paid by the seller to the courier for transport with remain with the courier.

In addition to what has been illustrated so far, the form is provided with a QR code that, at the moment of checking of the item by the courier, will be scanned, opening the corresponding procedure and then at least one photograph will be taken of the item so as to certify that it corresponds to what is described in the form.

When the courier takes charge of the package, the courier will check the contents thereof, (comparing the item with the data entered on the printed form, with the photograph and with the request sent by email, thus there is a triple check) and will proceed with transport and delivery to the buyer. In particular, the check consists of ascertaining the conformity but not the operation of the item.

When the courier checks the item, if the courier finds that the item does not correspond to what was disclosed in the form, the courier will automatically return the package to the seller and the money contained in the virtual box will be returned to the buyer.

At this point, the courier 10 proceeds with delivering the item to the buyer and if the buyer is not found two times running, an alert message will be issued and the package will return to the seller and the money contained in the “virtual box” will be returned to the buyer, any cost of the double shipment being automatically deducted. Tracking of the package is visible to both parties in a prospect dedicated to the shipment methods (FIG. 14C8 and FIG. 14C9).

Once delivery has occurred, the buyer will have 12 hours' time to check conformity of the item and if no further selection has been made such as, for example, return, the money contained in the “virtual box” will be credited to the seller.

At this point, the procedure reaches the last step, which is the step of closing the transaction.

In this step, the buyer has two possibilities of behaviour (FIG. 9): close the transaction and activate the transfer of the money from the “virtual box” to the seller or open a return procedure if the item or the operation thereof do not correspond to what is agreed or to expectations. The buyer will in turn have to pay the courier the return shipment cost and return the package to the courier.

The procedure provides an optional step in which legal proceedings are opened.

When a dispute is opened, customer care will evaluate the contents of the virtual procedure (chat, photographs, transactions, confirmations by the courier etc.) and will decide in a short time how to proceed to close the negotiation. In the case of no agreement and closure, everything will be forwarded to the authorities, who will deal the situation without further investigations. This management method will drastically reduce the time taken to meet an order and will enable the legal proceedings to be closed rapidly.

In addition to what has been illustrated so far, the procedure offers the possibility of collection in person of the chosen item.

More in detail, collection in person (step 14 of FIG. 1) follows the same path that was described previously as far as the third step, i.e. the step of “sending money to the virtual box and photographs” as disclosed previously, with the difference that the buyer will have the option of setting a deadline for the transaction (e.g. 2 days or a time within which the meeting has to occur) as shown in FIG. 14A7.

There may be three possibilities at the moment of meeting between the buyer and seller.

The first in which the buyer can add or remove money from the virtual box in which the buyer had previously placed the money if differences are detected from the agreed amount such as for example defects that were not previously detected.

The second possibility occurs if the sale has not been completed because of any other problem so that it suffices to close the procedure. In this manner, after 12 hours from the deadline set by the buyer, the box will be emptied and the money will return to the buyer.

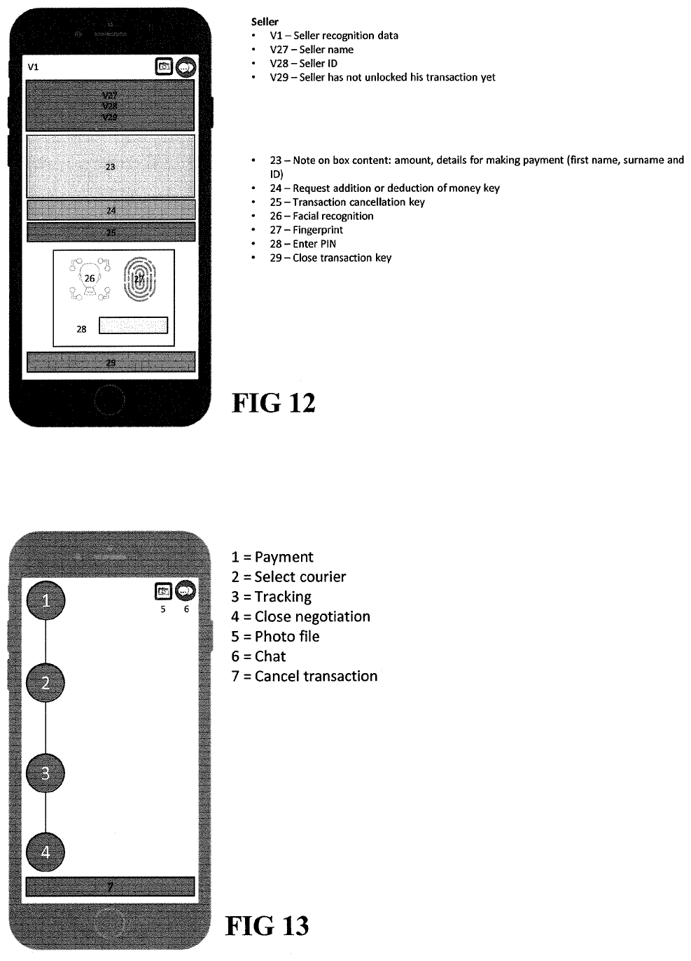

The third possibility occurs when both parties are interested in closing the negation. In fact, once the two parties meet, it is sufficient for both (buyer and seller) to enter their own virtual procedure and each enter the necessary credentials in the respective profile like: fingerprint, facial recognition and security PIN. At the moment in which both parties have carried out this operation, the amount contained in the virtual box will be released and will be credited to the seller (FIG. 12) and the buyer will take possession of the item (FIG. 13).

If one of the two parties does not complete the procedure of releasing the box, the transaction will remain on standby and after 12 hours from the deadline set by the buyer, the box will be emptied and the money will return to the buyer.

In addition to what has been illustrated so far, the recipients of this interchange system are all natural persons (not companies) who decide to engage in a transaction that involves shipment of a package or collection in person.

The procedure in question permits intervention on the payment processes, which until today have given both parties too much freedom of movement. By organizing the various steps in a constrained manner, choices and the movement possibilities of both users are limited and above all by operating in a procedure of “witness transfer” between the parties, all the choices are constrained. Further, all the steps are clearly visible to both the buyer and the seller and the management method is a constrained alternating system that leaves no space for anybody to escape the system.

For example: the procedure in question is a constrained alternating block system that is similar to a set in a tennis match in which the buyer and the seller are the two players.

The set (transaction) occurs in full view—in fact all the steps that are performed, the tracking control and the payments check are visible to both parties and in the event of a dispute, also to the customer care or to the authorities—and the “ball” transfers that occur from one part to the other of the court, i.e. the choices are obligatory that the two users have and make by alternating with one another. The two parties engaged in the transaction have the option of being able to make “direction” choices that have to remain within the area of play, otherwise the set—the open procedure—ends and the transaction is closed.

If, apparently, it could seem that the sale relates only to the buyer and the seller, in reality the interested parties are, as already explained, three. In fact, the courier plays a fundamentally important role because the courier determines the timing of the shipment, the certainty for the buyer that the package has actually been shipped and the security for the seller that the object is actually collected when it arrives at destination.

In addition, this procedure ensures an additional check for the envisaged payment method: in fact, the courier will have the obligatory duty (in the transaction it is set as an automatic choice) of checking the correctness of the contents of the package, but as has already been written, not the operation of the object.

In accordance with this invention and in addition to what has been illustrated until now, the workstation in question is set up to operate according to the following operating steps between the buyer (A) and seller (B):
a preliminary request is sent to open a virtual procedure, (1)—FIG. 14A3,
the procedure is closed if the request is refused or in the event of given period of inactivity (2),
the preliminary request is accepted and the virtual procedure (3) is opened—FIG. 14B1,
   a transaction request is sent, (4)—FIG. 14A4,
   the procedure is closed if the request is refused or in the event of given period of inactivity (5),
   the request is formally accepted (6)—FIG. 14B2,
   the box is emptied and the amount credited back to the buyer (after 12 hours) if the seller does not proceed with the step (7), despite having seen the payment and received the notice,
   the courier is selected (FIG. 14B3) and shipment costs are paid by the seller (8)—FIG. 14B4,
   the box is emptied and the amount credited back to the buyer (after 12 hours) if the seller does not proceed with the selection of the courier (9),
   the courier emails both parties, sends a data form to the seller, collects the package from the seller, tracks (FIG. 14C8), delivers to the buyer (10)—FIG. 14C9,
   the buyer checks conformity of the goods within 12 hours (if the buyer does not make any choice the money contained in the “virtual box” will be credited to the seller) (11),
   the transaction is closed with the transfer of the money from the “virtual box” to the seller (FIG. 14A6, FIG. 14B5 and FIG. 14C11), or
   a return procedure is opened because of nonconformant material and a courier is selected for return of the item with payment of the shipment costs by the buyer (12),
   an email is sent by the courier to both parties by sending the modified data form to the buyer, collection of the package by the buyer, tracking, delivery to the seller (13),
   seller retakes possession of the item (14),
   emptying of the virtual box VB with return of the money to the buyer, when the object is returned (or after 2 unsuccessful deliveries by the courier to the seller) (15).

The previously listed steps are listed in the diagram of FIG. 1.

In addition, the check by the courier is a necessary step, but if the two parties decide to avoid the check by the courier they may do so provided that the non-check request is entered by both parties.

The procedure involves the optional step of:
opening of a dispute, customer care will evaluate the content of the virtual procedure (chat, photographs, transactions, confirmations by the courier etc.) and will decide in a short time how to proceed to close the negotiation (16). As already said, in the event of more important and demanding problems, customer care will transmit all the contents of the procedure to the authorities, who will manage the procedure without further investigations, ensuring rapid closure of the legal proceedings.

In the sequence of FIG. 14, the sequence of steps between the seller and buyer in the sale of an item is shown. More in detail, the black screen is the screen of the buyer whilst the blue screen is that of the seller and the grey screen shows the clear screen that both parties can see.

This invention thus achieves the set aims.

The workstation for internet transactions between non-business users in question enables all users to select the items without fear of risking falling victim to fake advertisements, the accounts being unique and having data that enables the subjects to be identified unequivocally. In addition, there is a payment process that is dedicated to non-business users to prevent fraud in the sale of goods.

In fact, the payment procedure ensures total transaction transparency and roots out the problem of possible fraud. By this system of exchanges that alternate and are constrained, both parties interact on the advancement of the negotiation, checking all the steps without modifying the system in a significant manner in order to carry out a scam. The procedure is divided into simple steps that enable the parties to be protected.

In particular, the workstation for internet transactions between non-business users modifies the setting of the account so as to make the account non-modifiable and/or falsifiable and above all unique.

Advantageously, the workstation for transactions on the internet between non-business users according to this invention enables total transparency of the sequence of the transaction operations to be obtained, protecting upstream both the buyer and the seller and ensuring that the seller obtains the sum of money only when the buyer receives the object and checks that it corresponds to the item chosen.

Further, the workstation for transactions between non-business users, by limiting and placing conditions on the choices and the possibilities of movement for both users, makes the users proceed in the sale operations with a procedure alternating between the parties, so as to constrain all the choices and make the steps clearly visible to both the buyer and the seller, obtaining a constrained system that leaves no space for anybody to avoid the system. Further, as illustrated previously, until today, there have been no systems that enable the sale transactions on the internet between non-business users to be protected whereas the workstation according to this invention enables this.

Not the least advantage of this invention is that it is significantly easy to use, easy to make and very functional.

Naturally, numerous changes and variations can be made to this invention that all fall within the scope of the inventive concept that characterizes the invention.

1-11. (canceled)

12. A system for internet transactions between non-business users comprising at least a workstation, a buyer device, a seller device, and a courier device, said devices being desktop devices or mobile devices which interact with one another to enable operations at said workstation, the desktop devices include: computers, monitors, printers, scanners, mouse, keyboards, and cameras, while the mobile devices include: smartphones, tablets, notebooks, ultrabooks, and the connection and interaction method between the different devices is via an internet or WiFi connection between the desktop devices and via a 3G, 4G, 4.5G, 5G, LTE, or WiFi connection between the mobile devices,
said workstation envisaging that the different devices interact reciprocally in response to actions by at least two parties, one of which is the buyer and the other the seller, and a third party, which is the courier for the shipping of an item sold from the seller and bought by the buyer, and
said workstation comprising an operating procedure to process a transaction with the sale of the item, payment thereof, and delivery thereof, that comprises a series of operating steps including: the entry of a request, a procedure being opened, money and photos being sold, shipping and delivery methods being chosen including a third party being chosen to act as the courier, and the transaction being closed with the item being delivered to the buyer and the money being transferred to the seller,
wherein
said workstation is configured to operate according to the following operating phases between a buyer and a seller:
the buyer interested in the purchase of an item offered for sale by the seller sends a preliminary request, which opens a virtual procedure involving the entry of the following data: a description of the item, an asking price, and a seller account ID,
the procedure is closed if refused by the seller or in the event of given period of inactivity,
the preliminary request is accepted and the virtual procedure formally opened,
a message of acceptance by the buyer is received,
a transaction request is sent;
the procedure is closed if the request is refused or in the event of given period of inactivity by the seller,
the request is formally accepted,
once the transaction has been formally accepted, the seller sends detailed information of the item accompanied by descriptive photos in order to better describe and illustrate the item concerned by the transaction,
the buyer places the agreed amount in a dedicated virtual box which is visible to both parties,
the seller checks that the agreed amount has been paid by the buyer, the box is emptied and the amount credited back to the buyer if (after a set period) the seller remains inactive, despite having seen the payment and received the notice,
the transaction continues with the courier being chosen for the delivery of the item from those accredited by the system, with entry of data such as the size of the package, the collection and delivery address, and payment of shipping costs for the seller,
the courier sends emails to both parties stating the date of acceptance of the item,
the courier sends the seller a form which has already been completed with the procedure and item details, which the seller must print out and place inside the package,
the seller delivers the package to the courier,
an alert message is issued if the seller is not available for the collection twice in a row,
the money contained in the virtual box is returned to the buyer, while the courier withholds the amount paid by the seller for shipping,
the package is accepted by the courier, which checks the contents (counterchecking it against the data provided on the printed form, the photo, and the request sent by email, thereby triple-checking everything),
the package is shipped, with tracking visible to both parties (through a window dedicated to collection and delivery to the buyer) and, if the latter is not available for receipt twice in a row, an alert message is issued, the package is returned to the seller and the money contained in the virtual box is returned to the buyer, with any expenses for the shipping both ways deducted automatically,
the package is received by the buyer who, within a set period, checks the item for compliance, and—if no selection is made thereby—the money contained in the virtual box is credited to the seller,
the transaction is completed with confirmation of the payment to the seller and closure of the procedure.

13. The system according to claim 12, wherein, in order to be operative, it is envisaged that the buyer works with a desktop computer equipped with a monitor and a printer to print material and forms or with a mobile device and, likewise, the seller works with a desktop computer connected to a scanner, with a camera to take photographs of the object which the party intends to put on sale or a mobile device, and a courier works with computers and printers, telephones, smartphones, tablets, and notebooks, so as to communicate and interact with both the seller and the buyer, as well as using means of transport such as cars, vans, or trucks, wherein the aforesaid various devices interact reciprocally via internet.

14. The system according to claim 12, wherein a preliminary step is envisaged in which an account is created for a user (either the seller or the buyer) wherein, in order to be able to interact during the different phases of the transaction for the sale of an object, the user must have their own account and must provide all their own data such as:
full name,
place and date of birth,
tax ID code collection address delivery address telephone number,
all the social networks for which the users have signed up Email,
creation of a password,
creation of a PIN for «collect in person» transactions,
security question and,
once an account has been created said preliminary phase comprises an exchange of emails between the system and the user to verify activation, which is confirmed by a message on the new user device.

15. The system according to claim 14, wherein in order to be able to make and receive payments the user must:
add at least one fingerprint or all fingerprints and/or add a facial recognition procedure, or provide an identity card scanning feature, provide a scan of a utilities bill.

16. The system according to claim 14, wherein once the data loading is complete, there is a verification step in which the system attributes the data to an account and assigns an ID code which renders each profile unique and when said user receives the ID code, a credit/debit card or the credentials of a bank account associated with the account of the system.

17. The system according to claim 12, wherein a returns procedure opening phase is envisaged for non-compliant items, for the buyer to return the item (choosing the courier and paying the shipping costs), and for the courier to send an email to both parties attaching the amended data sheet in the email to the buyer, collect the package from the buyer, and transport and deliver the latter to the seller, which regains possession of the item, followed by the virtual box being emptied and the money returned to the buyer (either when the object is returned or after two failed delivery attempts by the courier to the seller).

18. The system according to claim 12, wherein an optional phase is envisaged in which a legal dispute may be begun wherein the assistance department will assess all the content of the virtual procedure (chat messages, photos, transactions, confirmations by the courier, etc.) and will decide, without delay, how to proceed in order to close the transaction and—in the event of failure to reach and agreement and subsequent closure—the case will be forwarded to the competent authorities, which will resolve with the dispute without further investigation.

19. The system according to claim 12, wherein said form contains a QR code which, upon item checks by the courier, will be scanned and will open the corresponding file and at least one photograph of the item will be taken to provide evidence of compliance with the specifications stated on the form and during the item check by the courier, should the item be found not to comply with the specifications on the form, the package will be automatically returned to the seller and the money contained in the virtual box will be returned to the buyer, the check consisting in the verification of the item's compliance with specifications but not the functionality thereof.

20. The system according to claim 12, wherein all the steps between the seller and the buyer are carried out within a chat message within the procedure in which all the information and data exchanged by the seller and the buyer and the contents of their conversations are collected and remain present for assessment and analysis by the assistance department in the event of a dispute between the parties and, once the procedure has been completed successfully, the chat message will be automatically erased.

21. The system according to claim 12, wherein a phase is envisaged in which the chosen item is collected in person in which the first transaction steps are the same through to the “sending money to the virtual box and photo” phase, except that the buyer will be entitled to enter a deadline for the transaction and/or a deadline by which the meeting must take place, wherein there are three options available to the buyer and the seller:
in the event that the buyer finds non-compliances in the item not noted earlier, the buyer will be able to add or remove money placed in the virtual box earlier thereby—the sale is unsuccessful if any other issue occurs which is sufficient to close the procedure and, after a set period from the deadline set by the buyer, the box will be emptied and the money returned to said buyer,
both parties are interested in closing the deal after the meeting and therefore both parties (buyer and seller) enter the necessary credentials in their virtual procedure and in their respective profiles, such as: fingerprints, face recognition, and security PIN, and once this operation has been completed by both parties, the amount contained in the virtual box will be released and will be credited to the seller and the buyer will come into possession of the item and if one of the two parties does not complete the box release procedure, the transaction will remain in stand by and after a set period from the deadline set by the buyer, the box will be emptied and the money will be returned to the buyer.
